(19) United States
(12) Patent Application Publication
(10) Pub. No.: US 2003/0208307 A1
(43) Pub. Date: Nov. 6, 2003

(54) Electrically powered vehicular device with automatic power reduction

(76) Inventors: Anthony A. Mirabelli, Arlington Heights, IL (US); William Chamberlain, Palatine, IL (US); Philip E. Thistlethwaite, Des Plaines, IL (US); Vincent C. Formanek, Hillside, IL (US)

Correspondence Address: Thomas K. Stine, Esq., WALLENSTEIN & WAGNER, LTD., 311 South Wacker Drive - 5300, Chicago, IL, 60606, US

(21) Appl. No.: 10/338,806

(22) Filed: Jan. 8, 2003

Related U.S. Application Data
(60) Provisional application No. 60/377,142, filed on May 2, 2002.

(51) Int. Cl. G06F 7/00

(52) U.S. Cl. 701/1

(57) ABSTRACT

An electrically powered vehicular device, such as a police radar detector, having an automatic reduced power feature, is disclosed.

### CROSS-REFERENCE TO RELATED APPLICATION

This application claims priority of U.S. provisional patent application, serial No. 60/377,142, filed May 2, 2002.

### TECHNICAL FIELD

The present invention relates to an electrically powered vehicular device, such as a police radar detector, having an automatic power reduction feature.

### BACKGROUND OF THE INVENTION

There are many electrically powered devices for communication and/or navigation, which are used today in vehicles, such as automobiles and boats. These devices typically operate from the vehicle's 12 volt electrical system via the vehicle's cigarette lighter socket. In many vehicles, power is available at the socket, even when the vehicle is turned off. Thus, if the device is not separately turned off when the vehicle is turned off, the device will continue to drain power from the vehicle's battery. If this occurs for an extended period of time, or if the battery otherwise has a low charge level, the device can drain power from the battery to a level where the vehicle will be unable to start.

This invention is directed to solving these and other problems.

### SUMMARY OF THE INVENTION

It is an object of the invention to provide for a vehicle having an electrical system and a source of DC power coupled to the electrical system, an electrically powered vehicular device with an automatic power reduction feature.

In accordance with the invention, the device comprises means for connecting the device to the source of DC power, means coupled to the connecting means for sensing whether the vehicle is turned on or off, and limiting means responsive to the sensing means for turning the device to a reduced power mode when the sensing means determines the vehicle is turned off.

It is contemplated that the reduced power mode is off, or alternatively a stand-by mode.

It is further contemplated that the sensing means includes means for monitoring background noise of the DC power; and means responsive to the monitoring means for determining that the vehicle is off if the background noise remains substantially constant over a period of time.

Alternatively it is contemplated that the sensing means includes means for sensing a voltage level of the DC power and means for monitoring a characteristic of the background noise of the DC power, and means responsive to the sensing means and the monitoring means for turning the device to reduced power mode when the sensed voltage level and the background noise characteristic each reach a set threshold.

It is yet further contemplated that the device includes means for over-riding the limiting means to permit the device to operate when the vehicle is turned off.

Other features and advantages of the invention will be apparent from the following specification taken in conjunction with the following drawings.

### BRIEF DESCRIPTION OF THE DRAWINGS

FIG. 1 is a block diagram of a device in accordance with the invention.

FIG. 2 is a logic flow chart of one part of the operation of the device of FIG. 1.

FIG. 3 is a logic flow chart of another part of the operation of the device of FIG. 1.

### DETAILED DESCRIPTION OF THE PREFERRED EMBODIMENT

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated.

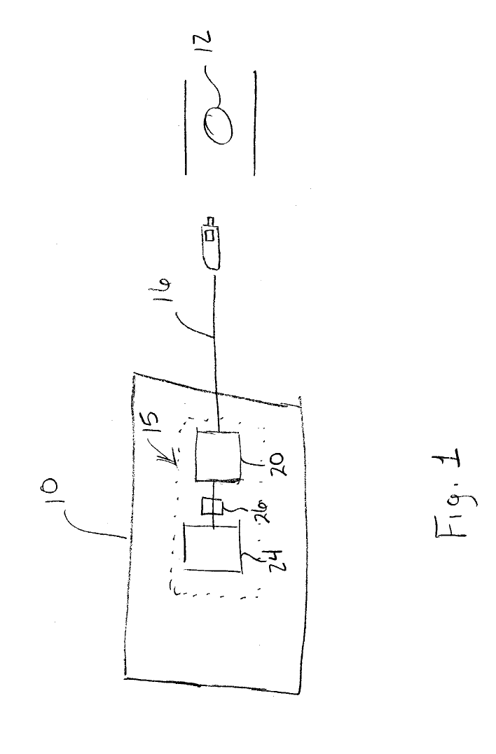

An electrically powered device 10 with automatic power reduction for use with a vehicle (not shown) is illustrated in FIG. 1. The device 10 may be a radar detector, a radio, such as a two way radio, a GPS receiver, or the like. The vehicle has an electrical system and a DC power source 12, such as a conventional cigarette lighter outlet, coupled to the electrical system.

The device 10 includes a power cord 16 for connecting the device 10 to the DC power source 12. The device 10 includes a circuit 15, coupled to the power cord 16. Alternatively, the circuit 15 may be located within a separate power cord for interchangeable use with different devices.

For a vehicle having a conventional 12 volt DC power system, the voltage level at its DC power source 12, when the vehicle is running with its alternator/generator charging, is typically above 13 volts, while the voltage level of a vehicle that is not running is typically about 12 volts. Similarly, the electrical noise of a vehicle that is running is typically varying, while the electrical noise of a vehicle that is not running is typically rather constant.

The device 10 continuously monitors the voltage level and the electrical noise at the DC power source 12. The device 10 uses a threshold voltage level of 13.05 volts. When the voltage goes below the threshold, a voltage level timer is initiated. Once the voltage level timer reaches five minutes, and if the electrical noise is considered to be constant (+/−10%), a noise level timer is initiated. Once the noise level timer is initiated, if the voltage level remains below the threshold, and the noise level timer reaches 25 minutes, the circuit 15 will power down the device 10. If at any time the voltage level equals or exceeds the threshold, the voltage level timer and the electrical noise timer will be reset, and the process will begin again. If at any time the electrical noise becomes variable, the electrical noise timer will be reset. In other words, for power down to occur, the voltage level must remain below the threshold for a 30 minute period and the electrical noise must remain constant for the last 25 minutes of the 30 minute period. It should be understood that the actual time periods can be varied, without departing from the invention.

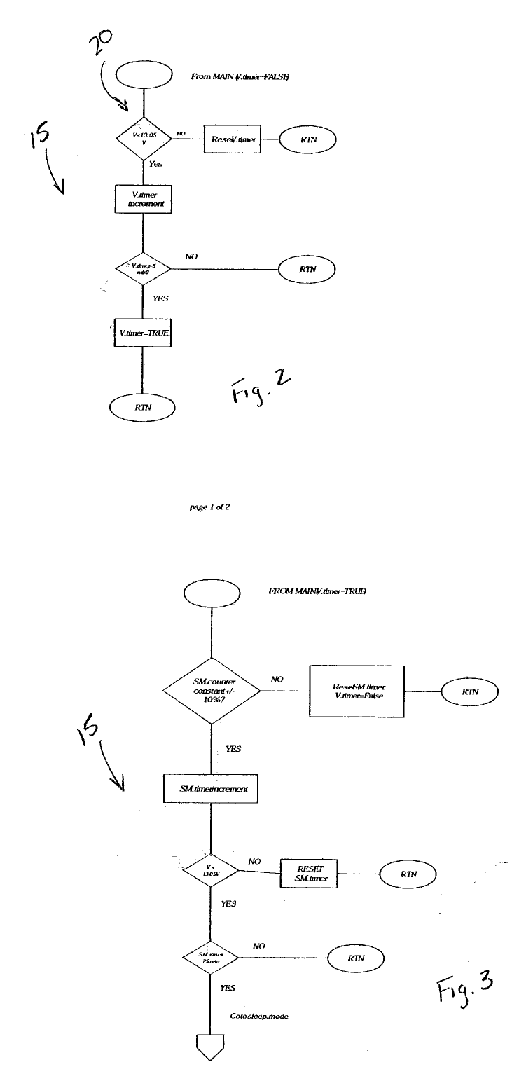

The circuit 15 of the device 10 is typically a microprocessor based product, having registers acting as the respective voltage level timer and electrical noise timer. Operation of the microprocessor with respect to the invention is discussed below with respect to FIGS. 2 and 3.

Referring to FIG. 2, monitoring circuitry 20 monitors the voltage level at the DC power source 12. Initially, if the microprocessor determines the voltage level is not less than 13.05 volts, the voltage level register is reset, and the microprocessor returns. If the microprocessor determines the voltage level is less than 13.05 volts, the voltage level timer register is incremented, and the microprocessor determines whether the voltage level timer register has reached 5 minutes. If not, the microprocessor returns. If it has reached 5 minutes, a voltage timer flag is set to True, to be discussed below with respect to FIG. 3.

Referring to FIG. 3, the monitoring circuitry monitors the electrical noise at the DC power source 12. Measurement of electrical noise is likewise described in co-owned application Ser. No. 10/040,907, which is incorporated by reference. If the microprocessor determines the electrical noise is not constant, the noise timer register is reset, and the microprocessor returns. If the microprocessor determines the electrical noise is constant, the noise timer register is incremented, and the microprocessor determines if the voltage timer flag is True. If not, the noise timer register is reset and the microprocessor returns.

If the voltage timer flag is True, the microprocessor determines if the noise timer register has reached 25 minutes. If not, the microprocessor returns. However, if the noise timer register has reached 25 minutes, the microprocessor powers down the device 10.

Similarly, if used with a device having GPS capability, the monitoring circuitry 20 can determine whether the vehicle is moving or not, and from that information over a period of time, make a decision that the vehicle is not running.

The device 10 further includes over-riding circuitry 26 for over-riding the circuit 15 to permit the device 10 to operate when the circuit 15 has determined that the vehicle is not running.

While the specific embodiment has been illustrated and described, numerous modifications come to mind without significantly departing from the spirit of the invention, and the scope of protection is only limited by the scope of the accompanying Claims.

1. For a vehicle having an electrical system and a source of DC power coupled to the electrical system, an electrically powered vehicular device with automatic power reduction, the device comprising:
means for connecting the device to the source of DC power;
means coupled to the connecting means for sensing whether the vehicle is turned on or off; and
limiting means responsive to the sensing means for turning the device to a reduced power mode when the sensing means determines the vehicle is turned off.

2. The device of claim 1 wherein the reduced power mode is off.

3. The device of claim 1 wherein the reduced power mode is a stand-by mode.

4. The device of claim 1 wherein the sensing means includes:
means for monitoring the voltage level of the source of DC power; and
means responsive to the monitoring means for determining that the vehicle is off if the voltage level drops to below a set threshold.

5. The device of claim 1 wherein the sensing means includes:
means for monitoring background noise of the source of DC power; and
means responsive to the monitoring means for determining that the vehicle is off if the background noise remains substantially constant over a period of time.

6. The device of claim 1, wherein the device is a radar detector.

7. The device of claim 1, wherein the device is a radio.

8. The device of claim 7, wherein the radio is a two way radio.

9. The device of claim 1, wherein the device is a GPS receiver.

10. The device of claim 1 including means for over-riding the limiting means to permit the device to operate when the vehicle is turned off.

11. An electrically powered vehicular device with automatic power reduction for use with a source of DC power coupled to an electrical system of a vehicle, the device comprising:
means for connecting the device to the source of DC power;
means coupled to the connecting means for sensing a voltage level at the source of DC power to determine whether the vehicle is turned on or off;
means responsive to the sensing means for turning the device to a reduced power mode when the sensed voltage level drops below a set threshold.

12. The device of claim 11 wherein the reduced power mode is off.

13. The device of claim 11 wherein the reduced power mode is a stand-by mode.

14. The device of claim 11 wherein the sensing means includes a voltage monitoring circuitry.

15. The device of claim 11 wherein the responsive means includes a switching circuitry.

16. An electrically powered vehicular device with automatic power reduction for use with a source of DC power coupled to an electrical system of a vehicle, the device comprising:
means for connecting the device to the source of DC power;
means coupled to the connecting means for monitoring background noise of the DC power source; and
means responsive to the monitoring means for turning the device to reduced power mode when the background noise drops below a set threshold over a period of time.

17. The device of claim 16 wherein the reduced power mode is off.

18. The device of claim 16 wherein the reduced power mode is a stand-by mode.

19. The device of claim 16 wherein the sensing means includes a voltage monitoring circuit.

20. The device of claim 16 wherein the responsive means includes a switching circuit.

21. An electrically powered vehicular device with automatic power reduction for use with DC power source coupled to an electrical system of a vehicle, the device comprising:
means for connecting the device to the DC power source;
means coupled to the connecting means for monitoring background noise of the DC power source;
means responsive to the monitoring means for turning the device to reduced power mode when the background noise remains substantially constant over a period of time.

22. An electrically powered vehicular device with automatic power reduction for use with a DC power source coupled to an electrical system of a vehicle, the device comprising:
means for connecting the device to the DC power source;
means coupled to the connecting means for sensing a voltage level at the DC power source;
means coupled to the connecting means for monitoring a characteristic of background noise of the DC power source;
means responsive to the sensing means and the monitoring means for turning the device to reduced power mode when the sensed voltage level and the background noise characteristic each reach a set threshold.

23. The device of claim 22 wherein the connecting means is a power cord.

24. The device of claim 22 wherein the sensing means includes a voltage monitoring circuit.

25. The device of claim 22 wherein the voltage monitoring circuit detects whether the voltage level of the DC power source drops below a threshold.

26. The device of claim 25 wherein the threshold is 13.05 volts.

27. The device of claim 22 wherein the background noise characteristic is noise level.

28. The device of claim 22 wherein the background noise characteristic is noise level over a period of time.

29. The device of claim 22 wherein the monitoring means includes a counter that determines the vehicle is off if the background noise characteristic is substantially constant over a period of time.

30. The device of claim 22 wherein the responsive means includes a switch.

31. A connector for coupling an electrically powered device to a DC power source, the connector for removing power to the device when the vehicle has been turned off, the connector comprising:
means for connecting the device to the DC power source;
means for sensing whether the vehicle is turned on or off; and
limiting means responsive to the sensing means for removing power to the device when the sensing means determines the vehicle is turned off.

32. The connector of claim 31 wherein the sensing means includes:
means for monitoring the voltage level of the DC power source; and
means responsive to the monitoring means for determining that the vehicle is off if the voltage level drops to below a set threshold.

33. The connector of claim 31 wherein the sensing means includes:
means for monitoring background noise of the DC power source; and
means responsive to the monitoring means for determining that the vehicle is off if the background noise remains substantially constant over a period of time.
